(19) United States
(12) Patent Application Publication
(10) Pub. No.: US 2004/0007235 A1
(43) Pub. Date: Jan. 15, 2004

(54) Intake valve

(75) Inventor: Ivan Rafoss, Sandnes (NO)

Correspondence Address: FROMMER LAWRENCE & HAUG LLP, 745 FIFTH AVENUE, NEW YORK, NY, 10151, US

(73) Assignee: Laerdal Medical AS, Stavanger (NO)

(21) Appl. No.: 10/365,253

(22) Filed: Feb. 12, 2003

(30) Foreign Application Priority Data
Jul. 15, 2002 (NO) 2002-3404

(51) Int. Cl. A62B 1/00

(52) U.S. Cl. 128/207.14

(57) ABSTRACT

Reusable intake valve for a resuscitation bag, comprising an inner part, an outer part, and a valve housing. The inner and outer parts are separate parts designed to be connected at an opening in the bag and to seal an edge of the opening between them. The inner part includes a first valve member designed to admit air into the bag and close for air flow in the opposite direction. The valve housing includes second and third valve members with the second valve member capable of admitting ambient air into the valve housing and close for air flow in the opposite direction. The third valve member is capable of releasing air from the valve housing to the surroundings when opened and close for air flow in the opposite direction. The valve housing includes a first pipe member for connection to an oxygen reservoir and a second pipe member for connection to an oxygen source. In this reusable intake valve, the outer part and the valve housing are integrated into one piece.

### BACKGROUND OF THE INVENTION

A. Field of the Invention

The present invention relates to a reusable intake valve for a resuscitator bag, and more particularly, to a reusable intake valve for a resuscitator bag which integrates certain components thereof.

B. Related Art

A resuscitator bag is used with a patient mask or an endotracheal tube to deliver air to and ventilate a patient with reduced or absent respiration. Resuscitator bags are frequently used by medical personnel in ambulances, hospitals and casualty wards.

In principle, the resuscitation equipment used by medical personnel includes, the resuscitator bag, which is a soft bag made of, for instance, silicon or PVC, a patient valve provided on the bag which controls the air into and from the patient, a mask or, alternatively, an endotracheal tube that leads the air into and out of the patient's respiratory passages, and an intake valve that admits air into the bag, and an oxygen reservoir, as well as an oxygen hose for delivery of oxygen to the bag. The delivery of oxygen to the oxygen reservoir occurs through an additional valve housing, allowing a higher oxygen concentration to be delivered to the patient.

Today's intake valves have remained relatively unchanged with respect to form and function since the 1960's. These intake valves generally had an inner part, an outer part, and a diaphragm valve that allows air to be sucked into the bag when the bag expands. The same diaphragm valve prevents air from flowing back out the same way, by means of the diaphragm closing the outlet in the opposite direction. Therefore, when the operator compresses the bag, air is forced out of the bag and into the patient.

With time, it has become more common to feed the patient extra oxygen to obtain improved treatment results. For that reason, it is known that the outer part of the intake valve may be constructed with two socket pieces, one for connection of oxygen and one for connection of an additional valve housing. This additional valve housing has several functions as follows related to the delivery of oxygen to the patient:

1. A connection point for an oxygen reservoir that collects oxygen between every compression of the resuscitator bag by the operator. With this, the bag can suck oxygen in from the reservoir every time the bag expands, and when the bag is used correctly, the patient can receive almost 100% oxygen instead of 21% oxygen, as is normal in atmospheric air. Oxygen from an oxygen tube connected to the outer part will fill the reservoir with a constant but adjustable flow of oxygen.

2. In the event of failure in the oxygen supply or in the reservoir, a diaphragm valve will allow atmospheric air to be sucked into the valve housing and into the bag.

3. In the case of an excessive admission of oxygen, relative to that required for the “bagging” (the repeated compression and inflation of the bag) and the volume of the reservoir, excess oxygen will be released through another diaphragm valve.

The existing intake valves require that a separate product (that is, the additional valve housing) be maintained in stock. If in stock, the operator must place the additional valve housing on the intake valve in order to obtain the desired function of providing supplemental oxygen to the patient during “bagging”.

In a known design owned by to the same assignee as the present application, the intake valve and the additional valve housing contain a total of nine separate components, of which 8 are non-identical. This leads to high production and assembly costs and involves a labor intensive process for the operator who reuses the products and needs to maintain them, among other things by completely disassembling the parts for cleaning and any required sterilization.

An intake valve with an integrated oxygen supply is also known from U.S. Pat. No. 5,163,424. However, this intake valve is designed to be disposable, together with the bag, patient valve and oxygen reservoir, i.e. the parts are not intended to be disassembled for cleaning. The valve housing is connected to the bag by means of the edge of the bag opening being placed in a groove in the valve housing. In order to achieve this connection, the bag opening must be expanded until it can be slipped into the groove. To prevent air from escaping between the bag and the valve housing and prevent the bag from slipping out of the groove when the bag is compressed, the edge of the bag must abut against the valve housing with a certain amount of force. Consequently, special tools are likely to be required in order to get the edge of the opening into the groove. And therefore, removing the edge of the opening from the groove again is difficult. In the commercially available disposable product, the transition between the bag and the valve housing is stapled together to prevent it from detaching. As such, this connection cannot be undone and reformed without damaging the product.

Furthermore, the oxygen reservoir is held in place by means of a sheath that is pulled over the valve housing. The sheath is provided with a bead that slips over an edge on the valve housing. It is probably not possible to remove the sheath again without damaging it or the valve housing. These two factors alone make this existing intake valve totally unsuited for multiple use.

### OBJECTS OF THE INVENTION

Therefore, it is an object of the present invention to provide an intake valve for a resuscitator bag which avoids the aforementioned deficiencies of the prior art.

It is also an object of the present invention to provide an intake valve for a resuscitator bag that integrates the functions of the known intake valve and the additional valve housing.

It is another object of this invention to provide an intake valve for a resuscitator bag which decreases production and assembly costs and is less labor intensive.

It is a further object of this invention to provide an intake valve for a resuscitator bag which is suitable for multiple use.

Various other objects, advantages and features of the present invention will become readily apparent from the ensuing detailed description and the novel features will be particularly pointed out in the appended claims.

### SUMMARY OF THE INVENTION

This invention relates to a reusable intake valve for installation at one end thereof to a resuscitator bag and for installation at another end thereof to an oxygen reservoir. This intake valve includes an inner part, an outer part and a valve housing formed integrally with the outer part.

The inner part of this reusable intake valve includes a first valve member movable between an open position, wherein air is admitted into the resuscitator bag, and a closed position, wherein air is prevented from entering the resuscitator bag when the resuscitator bag is compressed. The outer part is connectable to the inner part at an opening in the resuscitator bag so as to substantially seal an edge of the opening between the inner and outer parts.

The integrally-formed valve assembly includes second and third valve members. The second valve member is movable between an open condition, wherein the second valve member admits ambient air therethrough when insufficient oxygen is present in the oxygen reservoir, and a closed condition, wherein the second valve member is prevented from passing ambient air therethrough. The third valve member is movable between an open condition, wherein the third valve member releases excess oxygen from the oxygen reservoir when the oxygen reservoir is full, and a closed condition, wherein oxygen is prevented from passing through the third valve member when the oxygen reservoir is not full.

Accordingly, the present invention relates to a new reusable intake valve for a resuscitator bag that integrates the functions of the known intake valve and the additional valve housing. This intake valve aims to significantly reduce the number of separate components that is required for the intake valve to function. According to a presently preferred embodiment, the total number of components has been reduced from nine to five, and the number of non-identical components has been reduced from eight to three. An additional component may also be utilized to protect the valve against external influences. This intake valve is thus easier to use, thereby providing increased patient safety.

The present invention can also provide the following additional benefits.

1. The same type of diaphragm valve can be used for three different functions while at the same time meeting the existing requirements for flow resistance. This simplifies the manufacturing process and maintenance of the product, thereby saving costs. Moreover, it results in the product having two spare valves. If the suction valve were to be damaged, a life-threatening situation may still be avoided by passing air through the remaining valves.

2. The diaphragm valves and the outer and inner parts can be designed to prevent or make it impossible not to detect, through prescribed testing, incorrect assembly (which may be life-threatening).

3. The construction of the integrated intake valve with two diaphragm valves may be realized by mounting the valves on the side faces of the outer part. This allows the use of larger types of diaphragm valves on an integrated intake valve than that which is possible with valves mounted in the same plane across the longitudinal axis of the bag. The larger diameter diaphragm valves can be pretensioned and constructed of a stiffer material, so as not to leak. At the same time, the larger diameter provides for a reduction in flow resistance. This ensures enhanced performance.

4. The new outer part of this intake valve functions even if it is installed on an old inner part by mistake, and conversely, a new inner part will function even if it is installed on an old outer part by mistake.

### BRIEF DESCRIPTION OF THE DRAWINGS

The following detailed description given by way of example, but not intended to limit the invention solely to the specific embodiments described, may best be understood in conjunction with the accompanying drawings in which:

FIG. 1 is an elevational view of a conventional resuscitator bag with a patient valve, an oxygen reservoir and an intake valve with an additional valve housing;

FIG. 2 is a front elevational view of a section of known intake valve having an attached additional valve housing FIG. 1 fitted on a resuscitator bag;

FIG. 3 is an exploded view of the known intake valve with an attached additional valve housing of FIG. 1;

FIG. 4 is a front elevational view of a preferred embodiment of a resuscitator bag with a patient valve, an oxygen reservoir and an intake valve according to teachings of the present invention;

FIG. 5 is an exploded view of the intake valve shown in FIG. 4; and

FIG. 6 is a partial sectional view of the intake valve of FIG. 4.

### DETAILED DESCRIPTION OF CERTAIN PREFERRED EMBODIMENTS OF THE INVENTION

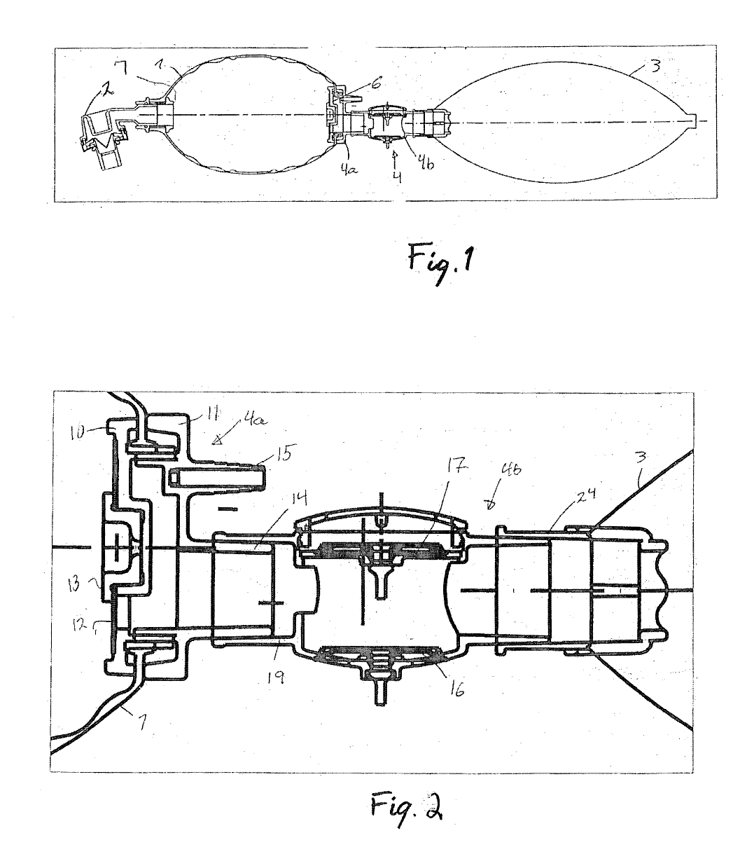

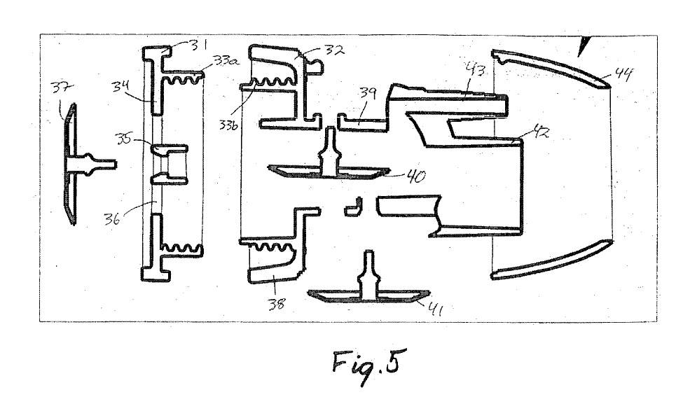

Referring now to the drawings, wherein like reference numerals represent like features in the several view, FIGS. 1 through 3 thereof illustrate a conventional intake valve with a separate additional valve housing attached thereto and FIGS. 4 through 6 illustrate an intake valve according to the teachings of the present invention which integrates the functions of the additional valve housing in a unitary structure. This analysis of the conventional art and present invention will highlight the advantages attained by the intake valve of the present invention.

In accordance therewith, FIG. 1 shows a resuscitator bag 1 with a patient valve 2, an oxygen reservoir 3 and an intake valve 4 according to the prior art. The intake valve 4 consists of the actual intake valve 4a and an additional valve housing 4b. The actual intake valve 4a is installed in a first opening 6 in the resuscitator bag 1.

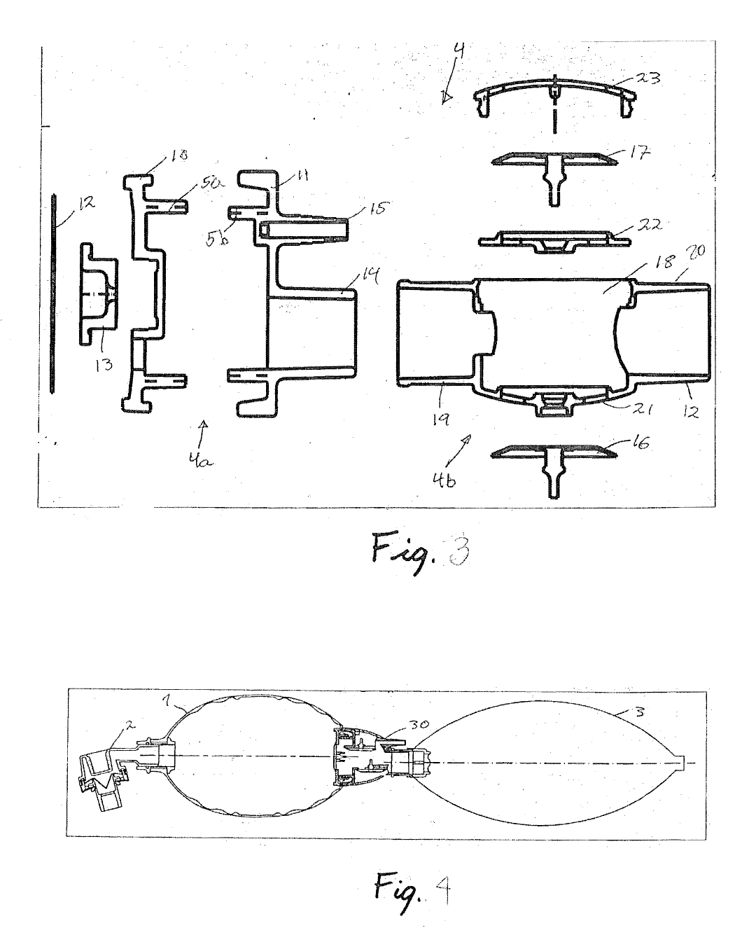

In operation, the oxygen reservoir 3 is filled from an oxygen source (not shown) via an oxygen connection 15 on the intake valve 4a (see FIG. 2). The oxygen flows into the housing of the intake valve 4a at a constant pressure, and via the additional valve housing 4b into the oxygen reservoir 3 in order to fill the oxygen reservoir 3.

When the operator compresses the bag 1, oxygen is forced out of the bag 1 through an opening 7 at the opposite end of the bag, and through the patient valve 2 to the patient. When the operator releases the grip on the bag 1 to allow the bag 1 to resume its non-compressed ball/almond shape, air/oxygen is sucked into the bag 1 from the oxygen reservoir 3. This oxygen flows via the additional valve housing 4b and the actual intake valve 4a into the bag 1.

The patient valve 2 is constructed so as to allow air from the bag into the patient. Exhaled air from the patient is prevented from flowing back to the bag, and is passed out to the surroundings. The patient valve will not be explained in greater detail, as its construction and operation is the same for this conventional art as in the present invention of FIGS. 4 through 6.

FIG. 2 is a longitudinal section of a known intake valve 4, and FIG. 3 shows the known intake valve in a disassembled state. The actual intake valve 4a is formed of an inner part 10, an outer part 11, a diaphragm 12 and a diaphragm holder 13. The outer and inner parts 10 and 11 include complementary threads 5a and 5b to allow the outer and inner parts 10 and 11 to be screwed together. The inner part 10 is placed on the inside of the resuscitator bag 1, and the outer part 11 on the outside of the bag 1, so that when these parts are screwed together at the bag opening 6, the bag is pinned between the parts, thus forming an airtight and secure connection between the intake valve 4a and the bag 1.

The diaphragm 12 and the diaphragm holder 13 are fitted in the inner part 10 by passing the diaphragm holder 13 through a hole in the diaphragm 12 and onto a screw connection in the inner part 10. As a result, the middle section of the diaphragm 12, is secured while the peripheral parts of the diaphragm 12 only rest against the inner part 10. In the case of an overpressure in the intake valve 4 relative to the bag 1, the peripheral parts of the diaphragm 12 will thereby be lifted away from their position of abutment against the inner part 10, allowing air to pass by the diaphragm 12. In the case of overpressure on the opposite side of the diaphragm 12, the peripheral parts of the diaphragm will be forced against the inner part 11 and thus will not allow air to pass therethrough.

As shown in FIGS. 2 and 3, the outer part 11 has a large diameter pipe stub member 14. The additional valve housing 4b is connected to the large diameter pipe stub member 14 and is capable of delivering air with a higher concentration of oxygen (alternatively 100% oxygen) than that of the ambient air to the patient. The additional valve housing 4b has a middle section 18 and two pipe stub members 19, 20 facing in opposite directions from the middle section 18. Two diaphragm valves 16 and 17 (so-called mushroom valves) are provided at the respective bottom and top ends of the middle section 18. The first diaphragm valve 16 is placed with its diaphragm abutting against the inside of a bottom wall 21 in the middle section 18, so as to open to pass air from the surroundings to flow into the intake valve, and close in the opposite direction preventing air from passing therethrough. The second diaphragm valve 17 is positioned with the diaphragm against the outside of top wall 22, which is attached to the middle section 18. This second diaphragm valve 17 opens for air from the additional valve housing 4b to flow out to the surroundings. A protective cover 23 is provided outside of the second diaphragm valve 17 to prevent objects (fingers) from blocking the valve function. However, air may pass by the cover 23.

FIGS. 2 and 3 illustrate that a pipe stub member 24 extends from an attached end of the oxygen reservoir 3 (see FIG. 2), and is fitted over pipe stub member 20 of the additional valve housing 4b.

In the prior art intake valve of FIGS. 1 through 3, the actual intake valve 4a also includes the aforementioned oxygen connection 15. As shown, the oxygen connection 15 has a smaller diameter than the pipe stub member 14. Oxygen is supplied through the oxygen connection 15 from an oxygen source (not shown).

When the resuscitator bag 1 of the prior art is compressed, the diaphragm 12 will, as a result of the increased pressure, press against the inner part 11 and prevent air out of flowing from the bag 1 and into the intake valve 4a. Oxygen will flow into the intake valve 4a via the oxygen connection 15, passing through the additional valve housing 4b and into the oxygen reservoir 3. If the oxygen reservoir 3 is completely filled before the compressed bag 1 is released, the second diaphragm valve 17 of the additional valve housing 4b opens to release the excess oxygen. In this regard, the second diaphragm valve 17 is pretensioned to open at a set pressure.

If, for some reason, the oxygen supply fails and the flow of oxygen is reduced or ceases completely, the first diaphragm valve 16 of the additional valve housing 4b will open when the bag 1 is released so as to create an underpressure in the bag. In so doing, ambient air will flow into the bag 1 from the open condition of the first diaphragm valve 16. The patient then receives ambient air with at least 21% oxygen.

The intake valve of the present invention will now be explained in greater detail with reference to a preferred embodiment shown in FIGS. 4 through 6.

As is shown in FIG. 4, the resuscitation equipment includes a resuscitation bag 1, a patient valve 2, an oxygen reservoir 3 and an intake valve 30 according to the teachings of the present invention. The resuscitation bag 1, the patient valve 2 and the oxygen reservoir 3 may be identical to those shown in FIG. 1, and as such these components will not be explained in further detail below, and the above description of those components for the resuscitation equipment of FIGS. 1 through 3 can be incorporated in this description regarding the embodiment of FIG. 4.

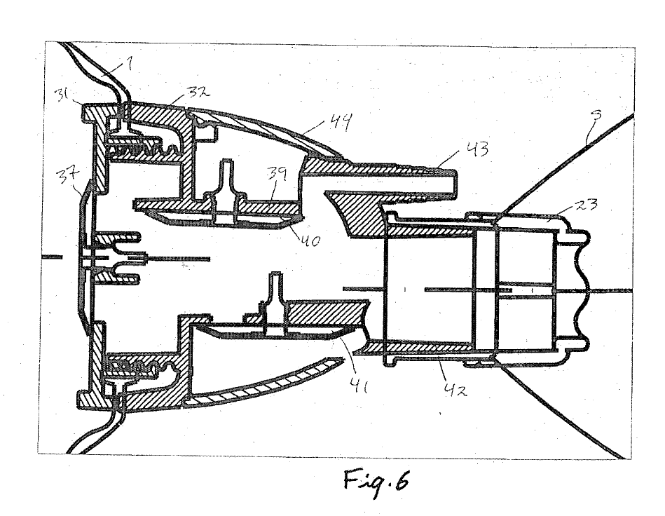

The intake valve 30 according to the invention will now be explained in greater detail with reference to FIGS. 5 and 6, where FIG. 5 is an exploded view and FIG. 6 is a longitudinal sectional view. The longitudinal section of the intake valve shown in FIG. 6, however, is not taken along one plane, but instead the left hand and right hand parts thereof are sections along two respective planes located at right angles to each other.

The intake valve 30 of FIGS. 4 through 6 has an inner part 31 and an outer part 32. The inner and outer parts 31 and 32 have complementary threads 33a and 33b that, in the same way as for the known intake valve 4a, pins the bag 1 between the inner and outer parts 31 and 32 when the parts 31 and 32 are screwed together.

As shown in FIG. 5, the inner part 31 includes a disc section 34 from which the threaded portion 33a projects. Furthermore, a sleeve portion 35 is formed centrally in the disc section 34. A plurality of openings, such as 36, are formed around the sleeve portion 35. The stem of a first valve member 37, which in principle is designed the same way as first and second diaphragm valves 16 and 17 in FIGS. 3 and 4 (that is preferably a mushroom valve), is pressed into the sleeve portion 35 and secured thereinto by a snap-fit. The snap-fit is preferred so as to allow the first valve member 37 to be removed by pressing against the valve stem or pulling the diaphragm.

FIG. 5 also illustrates that the outer part 32 includes a cup-shaped portion 38 extending outside the threaded portion 33b, and which in the secured arrangement pins the resuscitator bag 1 between itself and the inner part 31. A valve housing 39 projects centrally in the cup-shaped portion 38, which valve housing 39 performs the same function as the valve housing 4b in FIGS. 2 and 3. However, the valve housing 39 is integrally formed with the outer part 32 of the intake valve 30 and is of a unitary construction with the outer part 32. Second and third valve members 40 and 41, preferably mushroom valves, are provided in the valve housing 39. The second and third valve members 40 and 41 are identical to the first valve member 37, so that the first, second and third valve members 37, 40 and 41 are interchangeable and thus simpler to retain in stock. The second valve member 40 is arranged with its diaphragm inside the housing 39, such that the second valve member 40 opens to external pressure, while the diaphragm of the third valve member 41 rests on the outside of the housing 39, so that the third valve member 41 opens to internal pressure. The third valve member 41 is pretensioned to open at a set pressure, in the same manner as the second valve member 17 of the conventional art of FIGS. 2 and 3. This pretensioning is attained in a manner that is known per se, in that the third valve member 41 is pushed against the valve housing 39 with a certain amount of force before the third valve member 41 snaps into place.

As best shown in FIGS. 5 and 6, a pipe stub member 42 projects from the valve housing 39. This pipe stub member 42 is mated with the pipe stub member 23 on the oxygen reservoir 3 (see FIG. 6). An oxygen connection 43 projects from the valve housing 39 for connection of an oxygen hose (not shown). Although it is difficult to illustrate in two-dimensions, the oxygen connection 43 preferably projects from the valve housing 39 on the side facing out of the plane of the paper. However, the oxygen connection 43 has been drawn in the plane of the paper in order to place it in a two-dimensional view.

A protective sheath 44 which is permeable to air may be guided onto the outside of the valve housing 39 and brought into abutment (e.g., snap-fit) against the outer part 32. The sheath 44 extends from the pipe stub members 42 and 43 to the outer part 32. As such, the sheath 44 covers at least an area between the outer part 32 and the pipe stub members 42 and 43 in order to protect the valve housing 39 and the second and third valve members 40 and 41 against external influences.

The principle of operation of the intake valve according to the present invention is in principle the same as for the known intake valve and the additional valve housing according to FIGS. 1 through 3. Oxygen flows in through oxygen connection 43 and into the oxygen reservoir 3. When the oxygen reservoir is full, the third valve member 41 opens to release excess oxygen.

When the bag 1 is compressed, the first valve member 37 closes, and air is forced out through the patient valve 2 to the patient.

If the oxygen supply fails, the second valve member 40 will open as soon as the bag 1 is released. This will result in the bag 1 drawing air from the surroundings through the valve member 40.

Preferably, the diaphragms of the valves 37, 40, 41 are identical and made from a silicon material, so as to make them interchangeable. Preferably, the outer part 32 including the integrally-formed valve housing 39 is made from a substantially inflexible transparent plastic material. The remaining parts of the intake valve 30 may also be made from the same substantially inflexible plastic material.

Preferably, the outer part 32 of the intake valve 30 according to the present invention is constructed so as to allow it to be connected to the inner part 31 of an intake valve of an existing type such as described in connection with FIGS. 1 through 3, which is marketed as Laerdal Silicone Resuscitator, under article number 51 04 00. This effectively eliminates the risk of a coupling of old and new parts having any consequences for proper operation.

Thus, the present invention provides a reusable intake valve that consists of very few parts, is easy to assemble and limits the chances for incorrect interconnection between components. In particular, a reusable intake valve has been provided which integrates the functions of the known intake valve and the additional valve housing. Further, the same type of diaphragm valve can be used for three different functions while at the same time meeting the existing requirements for flow resistance. Moreover, the present invention reduces the total number of separate components from nine to five, and reduces the number of non-identical components from eight to three. Additionally, this intake valve is easier to use as no valve component parts need to be assembled, thereby providing increased patient, safety.

Although the invention has been particularly shown and described with reference to certain preferred embodiments, it will be readily appreciated by those of ordinary skill in the art that various changes and modifications may be made therein, without departing from the spirit and scope of the invention. It is intended that the claims be interpreted as including the foregoing as well as various other such changes and modifications.

What is claimed is:

1. A reusable intake valve for installation at one end thereof to a resuscitator bag and for installation at another end thereof to an oxygen reservoir, said reusable intake valve comprising:
an inner part including a first valve member movable between an open position, wherein air is admitted into the resuscitator bag, and a closed position, wherein air is prevented from entering the resuscitator bag when the resuscitator bag is compressed;
an outer part connectable to the inner part at an opening in the resuscitator bag and substantially sealing an edge of the opening between said inner and outer parts, said outer part further including a valve assembly integrally formed therewith, said valve assembly having second and third valve members, wherein said second valve member is movable between an open condition, wherein said second valve member admits ambient air therethrough when insufficient oxygen is present in the oxygen reservoir, and a closed condition, wherein said second valve member is prevented from passing ambient air therethrough, and said third valve member is movable between an open condition, wherein said third valve member releases excess oxygen from the oxygen reservoir when the oxygen reservoir is full, and a closed condition, wherein oxygen is prevented from passing through the third valve member when said oxygen reservoir is not full.

2. The reusable intake valve according to claim 1 wherein said outer part includes an oxygen connection for connection to an oxygen source.

3. The reusable intake valve according to claim 1 wherein said valve assembly of said outer part includes a pipe member extending therefrom for connection of said outer part to said oxygen reservoir.

4. The reusable intake valve according to claim 1 wherein said first, second and third valve members are identical and interchangeable.

5. The reusable intake valve according to claim 4 wherein said first, second and third valve members are mushroom-type valves.

6. The reusable intake valve according to claim 4 wherein said first, second and third valve members comprise:
a diaphragm; and
a stem attached to the diaphragm, the stem capable of engaging openings in the intake valve for a snap-fit therewith.

7. The reusable intake valve of claim 6 wherein the stem of the second valve member passes from the outside and through a side wall in the valve assembly such that the second valve member opens to external pressure, and the stem of the third valve member passes from the inside of the valve assembly and through a side wall of said valve assembly so that the third valve member opens to internal pressure.

8. The intake valve according to claim 1 wherein said first valve member is snap-fit into an opening of a sleeve portion of said inner part.

9. The reusable intake valve according to claim 1 wherein said second and third valve members are snap-fit into openings provided in said valve assembly of said outer part.

10. The reusable intake valve according to claim 1 wherein the third valve member is pretensioned to open at a set pressure.

11. The reusable intake valve according to claim 1 wherein said inner and outer parts have complementary threaded portions so as to pin the resuscitator bag between said inner and outer parts when said inner and outer parts are threadably secured.

12. The reusable intake valve of claim 1 and further comprising:
a first pipe member of said valve assembly of said outer part for connection of said outer part to the oxygen reservoir;
a second pipe member of said valve assembly of said outer part for connection of said outer part to an oxygen source; and
a sheath covering the outside of said valve assembly and extending from said first and second pipe members to the outer part in order to protect said second and third valve members of said valve assembly from external influences.

13. The reusable intake valve of claim 1 wherein said outer part including said integrally-formed valve assembly is made from a substantially inflexible transparent plastic material.

14. A reusable intake valve for installation at one end thereof to a resuscitator bag and for installation at another end thereof to an oxygen reservoir, said reusable intake valve comprising:
an inner part including a first valve member for admitting air into the resuscitator bag; and
an outer part connectable to said inner part at an opening in the resuscitator bag and substantially sealing an edge of the opening between said inner and outer parts, said outer part further including a valve assembly including a second valve member which when opened admits air into said valve assembly, and a third valve member which when opened releases air from said valve assembly, and wherein said outer part and said valve assembly are formed of a unitary construction.

15. The reusable intake valve of claim 14 wherein:
said first valve member is movable between an open position, wherein air is admitted into the resuscitator bag, and a closed position, wherein air is prevented from entering the resuscitator bag when the resuscitator bag is compressed;
said second valve member is movable between an open condition, wherein said second valve member admits ambient air therethrough when insufficient oxygen is present in the oxygen reservoir, and a closed condition, wherein said second valve member is prevented from passing ambient air therethrough; and
said third valve member is movable between an open condition, wherein said third valve member releases excess oxygen from the oxygen reservoir when the oxygen reservoir is full, and a closed condition, wherein oxygen is prevented from passing through said third valve member when the oxygen reservoir is not full.

16. The reusable intake valve of claim 15 wherein said first, second and third valve members are identical and interchangeable.

17. The reusable intake valve of claim 16 wherein said first, second and third valve members are mushroom-type valves.

18. The reusable intake valve of claim 15 wherein said first, second and third valve members comprise:
a diaphragm; and
a stem attached to the diaphragm, the stem capable of engaging openings in the intake valve for a snap-fit therewith.

19. The reusable intake valve of claim 18 wherein the stem of the second valve member passes from the outside and through a side wall in the valve assembly such that the second valve member opens to external pressure, and the stem of the third valve member passes from the inside of the valve assembly and through a side wall of said valve assembly so that the third valve member opens to internal pressure.

20. The reusable intake valve of claim 15 wherein said first valve member is snap-fit into an opening of a sleeve portion of said inner part.

21. The reusable intake valve of claim 15 wherein said second and third valve members are snap-fit into openings provided in said valve assembly of said outer part.

22. The reusable intake valve of claim 15 wherein the third valve member is pretensioned to open at a set pressure.

23. The reusable intake valve of claim 14 wherein said outer part includes an oxygen connection for connection to an oxygen source.

24. The reusable intake valve of claim 14 wherein said valve assembly of said outer part includes a pipe member extending therefrom for connection of said outer part to said oxygen reservoir.

25. The reusable intake valve of claim 14 wherein said inner and outer parts have complementary threaded portions so as to pin the resuscitator bag between said inner and outer parts when said inner and outer parts are threadably secured.

26. The reusable intake valve of claim 14 and further comprising:
a first pipe member of said valve assembly of said outer part for connection of said outer part to the oxygen reservoir;
a second pipe member of said valve assembly of said outer part for connection of said outer part to an oxygen source; and
a sheath covering the outside of said valve assembly and extending from said first and second pipe members to the outer part in order to protect said second and third valve members of said valve assembly from external influences.

27. The reusable intake valve of claim 14 wherein said outer part including said integrally-formed valve assembly is made from a substantially inflexible transparent plastic material.
